(19) United States
(12) Patent Application Publication
(10) Pub. No.: US 2008/0165257 A1
(43) Pub. Date: Jul. 10, 2008

(54) Configurable pixel array system and method

(75) Inventor: Ulrich Boettiger, Boise, ID (US)

Correspondence Address: Michael G. Fletcher;Fletcher Yoder, P.O. Box 692289, Houston, TX, 77269-2289, US

(73) Assignee: Micron Technology, Inc.

(21) Appl. No.: 11/650,215

(22) Filed: Jan. 5, 2007

(51) Int. Cl. H04N 5/228; H04N 5/335

(52) U.S. Cl. 348/222.1; 348/294; 348/E05.091; 348/E05.031

(57) ABSTRACT

Embodiments of the present invention relate to an image sensor that may be used for digital photography. One embodiment of the present invention may include an image sensor comprising a substrate, a plurality of pixel cell arrays disposed on the substrate, a first array of the plurality of pixel cell arrays including pixels of a first size, a second array of the plurality of pixel cell arrays including pixels of a second size, the second size differing from the first size, and a plurality of photographic lenses, each of the plurality of photographic lenses arranged to focus light onto one array of the plurality of pixel cell arrays.

### BACKGROUND OF THE INVENTION

1. Field of the Invention

The present invention relates generally to the field of semiconductor devices and more particularly to multi-array image sensor devices.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Digital cameras, much like conventional cameras, generally include a lens or series of lenses that focus light to create an image of a target scene. The lens or series of lenses may be referred to as a photographic lens or objective lens. A photographic lens may be utilized to focus and/or magnify an image. In contrast to photographic lenses in conventional cameras, which focus light onto film, digital cameras utilize photographic lenses to focus light onto a semiconductor device that records the light electronically at individual image points (e.g., pixels or photosites). For example, instead of film, a digital camera may include a sensor (e.g., a charge coupled device (CCD) or a complementary metal oxide semiconductor (CMOS)) that converts light into electrical charges. These electrical charges are essentially stored or recorded. Once the light is recorded as electrical charges, a computer may process the recorded light into digital data that may be used to provide images.

Traditional digital camera sensors typically include an array of sensor pixel cells or photosites that convert light into electricity. The number of pixels or photosites utilized by a digital camera generally determines the resolution (i.e., the amount of detail) of images captured by the camera. These photosites are essentially colorblind. In other words, the photosites merely convert light into electricity based on the total intensity of light that strikes the surface. Accordingly, digital cameras typically utilize color filters and microlenses for each photosite to provide color images. For example, a sensor may have red, blue, and green filters disposed in a Bayer filter pattern over the photosites, and the microlenses may direct light into each photosite via the associated filter. Once the camera sensor records all three colors, it may combine them to create a full spectrum. However, crosstalk among pixels (e.g., light passing through a filter and contacting a photosite adjacent the intended photosite) can reduce color reconstruction capabilities. Further, other aspects of traditional digital camera sensors can limit functionality.

### BRIEF DESCRIPTION OF THE DRAWINGS

Advantages of the invention may become apparent upon reading the following detailed description and upon reference to the drawings in which:

FIG. 1 is a top plan view of a multi-array image sensor with three mini-cameras in accordance with an exemplary embodiment of the present invention;

FIG. 2 is a top plan view of a multi-array image sensor with four mini-cameras in accordance with an exemplary embodiment of the present invention;

FIG. 3 is a cross-sectional view of two mini-cameras of the multi-array image sensor in FIG. 2, wherein the mini-cameras have different focus distances in accordance with an exemplary embodiment of the present invention;

FIG. 4 is a top plan view of a multi-array image sensor with a first mini-camera that includes a high density pixel array, a second mini-camera that includes a low density pixel array, a third mini-camera that includes a peripheral vision array, and a fourth mini-camera that includes a central vision array in accordance with an exemplary embodiment of the present invention; and

FIG. 5 is a perspective view of a digital camera that includes a sensor in accordance with an exemplary embodiment of the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention are directed to multi-array image sensor devices for use in digital cameras. In contrast to traditional digital camera sensors which typically include a single monolithic array of pixels or photosites, present embodiments include flexibly sized clusters of pixels on a single die with each cluster having its own imaging lens system and/or filter above it. These arrangements of lenses, pixel clusters, and filters essentially form multiple embedded mini-cameras (i.e., small functional cameras) on each die. In accordance with present embodiments, the clusters for each mini-camera may be configured with differently sized pixels, different pixel arrangements, multiple lens types, and/or multiple color filter arrangements (e.g., a single color filter, no color filter, or a mosaic filter) based on the desired operation of the mini-camera.

Because characteristics (e.g., lens type, filter arrangements, pixel arrangements) of the mini-cameras are flexible, each mini-camera can be optimized for a specific aspect of imaging (e.g., color detection, high sensitivity or dynamic range, or large depth of field). Indeed, by combining the performances of multiple pixel arrays or clusters in accordance with present embodiments, it is believed that more versatile imaging results may be achieved than would be achieved with the large monolithic arrays utilized in traditional digital cameras (e.g., digital photo and video cameras). It should be noted that the terms “pixel,” “pixel cell,” or “photosite” may refer to a picture element unit cell containing a photo-conversion device for converting electromagnetic radiation (e.g., light) into an electrical signal.

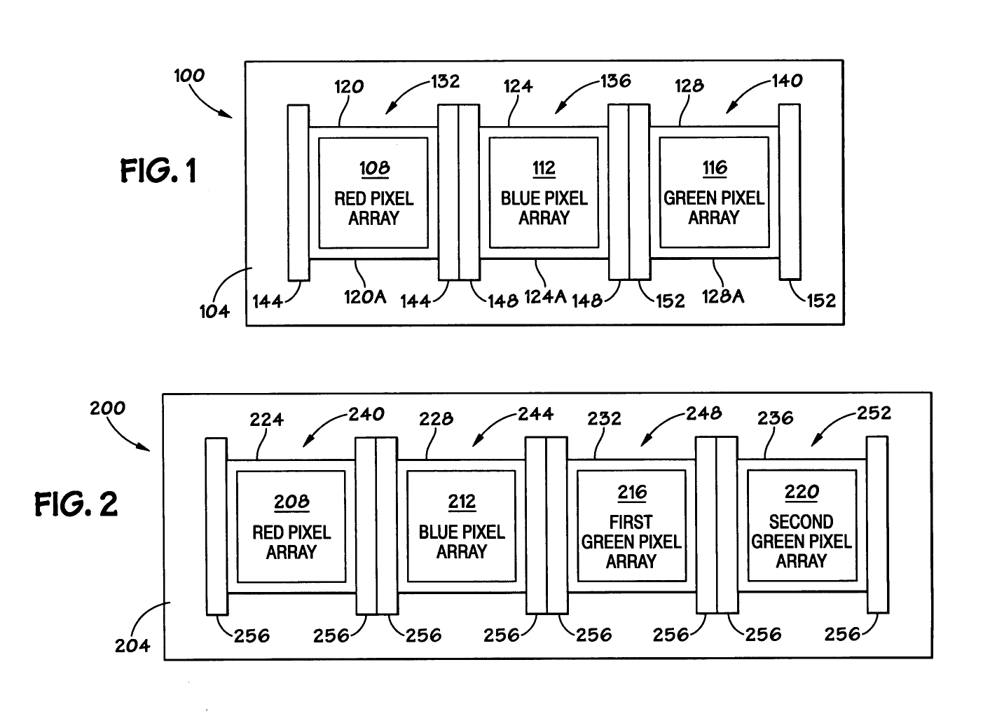

FIG. 1 is a top plan view of a multi-array image sensor 100 in accordance with an exemplary embodiment of the present invention. Image sensor 100 includes a substrate 104, a red pixel array 108, a blue pixel array 112, and a green pixel array 116. It should be noted that while three arrays are illustrated in FIG. 1, the number of arrays is only limited for exemplary purposes. Indeed embodiments of the present invention may include many arrays working together. Each pixel array 108, 112, and 116 includes a corresponding photographic lens. Specifically, with respect to the position of the substrate 104 as a base, the red pixel array 108 is disposed beneath a first photographic lens 120, the blue pixel array 112 is disposed beneath a second photographic lens 124, and the green pixel array is disposed beneath a third photographic lens 128. Each pixel array is arranged with other sensor features such that it detects a specific color of light. The color designation (e.g., red, blue, and green) for each pixel array 108, 112, and 116 may be determined by associated filters 120A, 124A, and 128A, which are adjacent to each lens 120, 124, and 128 and/or incorporated within each lens 120, 124 and 128. For example, the red pixel array 108 may be designated as red because it corresponds to a red filter that substantially blocks light other than red light from reaching the red pixel array 108. In some embodiments, color filters may be embedded within the lenses. For example, the filters 120A, 124A, and 128A may be a tint on each lens 120, 124, and 128. Further, in some embodiments, one or more arrays may not be associated with a filter or may receive light through a clear filter. It should be noted that the term “photographic lens” may be defined as an integrated system comprising one or more simple optical lens elements.

In some embodiments, one or more of the pixel arrays 108, 112, and 116 may be configured to detect multiple colors. For example, in one embodiment, one of the pixel arrays 108, 112, or 116 may be substituted for a pixel array with a Bayer pattern filter instead of a monochrome (i.e., one-color) filter. However, having pixel arrays with uniform color may facilitate the reduction of crosstalk artifacts because the pixel arrays and associated filters can be completely isolated from one another. In other words, using multiple monochrome arrays instead of a single large Bayer array reduces color filter induced diffraction effects in the pixels. For example, light passing through the blue filter 124A can be prevented or substantially prevented from activating an adjacent pixel intended to record red light (e.g., a pixel of the red pixel array 108) because the pixels can be sufficiently distanced to prevent such crossover. This type of isolation is generally not achieved using traditional techniques associated with large monolithic arrays. Also, with multiple arrays, more than three color filters can be used to improve color rendition without having to pixelize them, which can be a special advantage when building imaging devices with arrays of very small pixels. Additionally, components in accordance with present embodiments essentially form multiple mini-cameras with smaller array sizes than a single large array. This size reduction allows a shorter image distance for the same maximum chief array angle. In other words, this reduces the maximum chief ray angle for the same field of view or facilitates reduction of the height of the optical system, thus allowing a camera in accordance with present embodiments to be thinner than traditional cameras.

In the illustrated embodiment of FIG. 1, three mini-cameras 132, 136, and 140 are generally formed by the pixel arrays 108, 112, and 116, the photographic lenses 120, 124, and 128, and/or associated filters 120A, 124A, and 128A. It should be noted that in some embodiments more or fewer mini-cameras may be utilized. Each mini-camera 132, 136, and 140 includes associated blocks of support circuitry. Specifically, camera 132 includes blocks 144, camera 136 includes blocks 148, and camera 140 includes blocks 152. Each support circuitry block facilitates operation of the associated pixel array. While these blocks of support circuitry 144, 148, and 152 would typically be disposed along the periphery of a traditional sensor (e.g., along the edges of a large monolithic pixel array), in the illustrated embodiment the blocks of support circuitry 144, 148, and 152 are arranged to separate the respective pixel arrays 108, 112, and 116. The separation provided by the support circuitry 144, 148, and 152 substantially prevents crosstalk among pixels (e.g., light passing through a filter and contacting a photosite adjacent the intended photosite), which facilitates color reconstruction (e.g., appropriate mixing of image data to provide an accurate image color). By utilizing the support circuitry 144, 148, and 152 as a crosstalk barrier, space is efficiently utilized on the substrate 104. This efficient use of substrate space facilitates size reduction of any camera utilizing the sensor 100. However, it should be noted that in some embodiments opaque barriers may be utilized to prevent crosstalk instead of the support circuitry 144, 148, and 152.

Because present embodiments utilize separate pixel arrays that have corresponding support circuitry, several other operational benefits may result. Specifically, more accurate images may be captured due to rapid scanning of the arrays. Indeed, during operation, pixel cells in an array may be read out one by one. Accordingly, by using separate arrays instead of a single monolithic array, present embodiments may scan each array in parallel. With multiple separate arrays, shorter signal pathways may be utilized. Thus, more pixels may be scanned in less time, which allows less potential for image distortion due to movement. The shorter signal pathways facilitate faster or lower power operation than a can be achieved with typical monolithic arrays with the same number of pixels. Further, each array may be configured for substantially optimal thermal management. Indeed, operation may improve by spacing the arrays to limit heat build-up. A more even distribution of heat sources across the substrate may yield a more uniform dark current and a more uniform signal response.

Pixel and array sizes, shapes, and arrangements may be adjusted in accordance with present embodiments to optimize or customize each mini-camera 132, 136, and 140 for different imaging tasks. Indeed, each mini-camera 132, 136, and 140 may be configured for a particular primary task by changing the associated pixel and/or array characteristics. For example, the sensitivity and resolution of each mini-camera may be adjusted based on the nature or purpose of each mini-camera. Specifically, for example, high resolution from the blue pixel array 112 of the camera 136 may not benefit a resulting image as much as high resolution from the green pixel array 116 of the camera 140. This discrepancy may be because the human eye is more sensitive to green in an image than blue. Accordingly, in some embodiments, the size of pixels in the blue pixel array 112 may be larger than in the green pixel array 116. Indeed, the pixels of the blue pixel array 112 may be twice as large as the pixels of the green pixel array 116, for instance. However, the blue pixel array 112 may have half as many pixels as the green pixel array 116, thus reducing detail captured by the blue pixel array 112. This facilitates maximization of the amount of useful image information recorded by the sensor per unit area of silicon or per unit of electric power spent in acquiring the image.

FIG. 2 is a top plan view of a multi-array image sensor 200 in accordance with an exemplary embodiment of the present invention. The image sensor 200 includes a substrate 204, a red pixel array 208, a blue pixel array 212, a first green pixel array 216, and a second green pixel array 220. In some embodiments, different color configurations and/or non-filtered pixel arrays may be utilized. Each of the pixel arrays 208, 212, 216, and 220 cooperates with a corresponding photographic lens 224, 228, 232, 236 to form respective mini-cameras 240, 244, 248, and 252. The mini-cameras 240, 244, 248, and 252 may include filters and may be cumulatively or individually configured for specific purposes. For example, the two green pixel arrays 216 and 220 may be included in the sensor 200 to provide additional detail in the green light band, which may improve visibility of a product image to the human eye. Further, the pixel arrays 208, 212, 216, and 220 may be configured such that the ratio of colored pixels is similar to that of a monolithic array with a standard Bayer pattern filter (e.g., one blue pixel and one red pixel for every two green pixels). It should also be noted that, in the illustrated embodiment, the sensor 200 includes a plurality of barriers and/or blocks of support circuitry 256 that separate the pixel arrays 208, 212, 216, and 220 to prevent crosstalk and efficiently utilize sensor space.

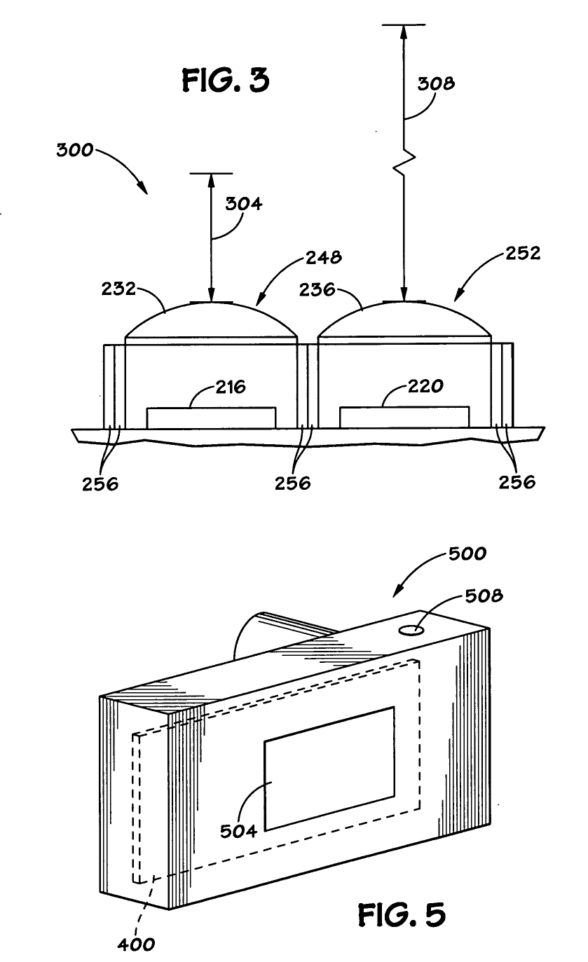

As set forth above, embodiments of the present invention may be configured or adjusted for specific purposes. An exemplary configuration of the image sensor 200 may include focusing the mini-camera 248 associated with the first green pixel array 232 on a nearby location or macro position, and focusing the mini-camera 252 associated with the second green pixel array 236 on a distant location (e.g., infinity). For example, FIG. 3 is a cross-sectional view 300 of the two mini-cameras 248 and 252 of FIG. 2, which shows the focus distances 304 and 308 for each of the cameras 248 and 252. By focusing the two mini-cameras 248 and 252 on different distances/locations, a built-in depth of field enhancement may be achieved after merging the sub-images using suitable image processing. It should be noted that in some embodiments more than two mini-cameras may be utilized to provide the depth of field enhancement. For example, multiple mid-range focused mini-cameras may be utilized and their product images may be merged with other images to produce a final image. Additionally, the use of multiple mini-cameras may facilitate three-dimensional imaging or depth measurement using the parallax shift between the different mini-cameras.

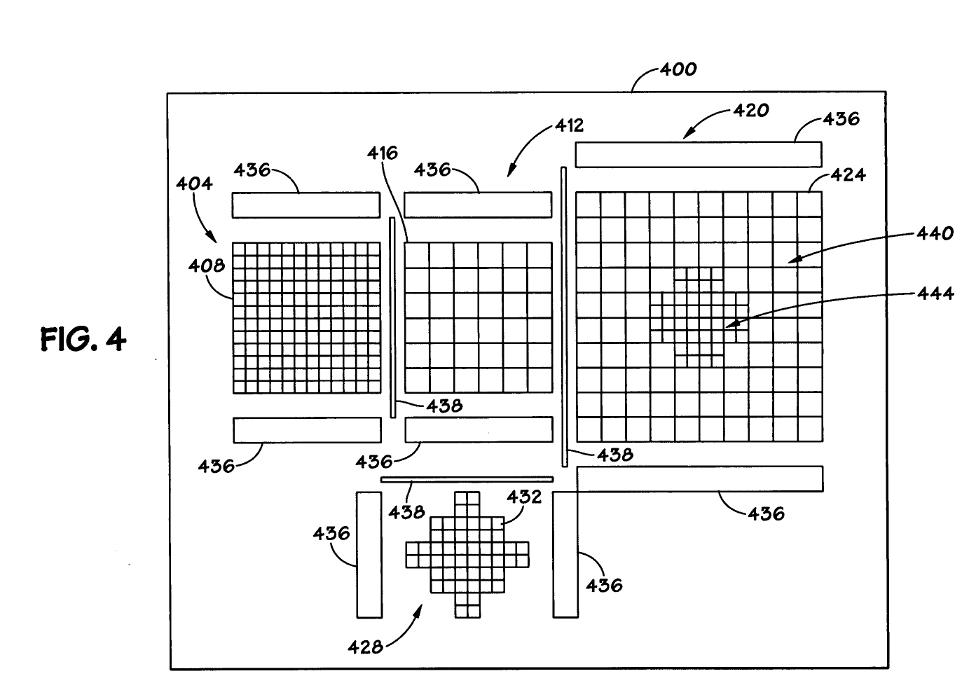

FIG. 4 is yet another embodiment of a sensor with a plurality of mini-cameras configured for specific operations in accordance with embodiments of the present invention. Specifically, FIG. 4 includes a sensor 400 with a first mini-camera 404 that includes a high density pixel array 408, a second mini-camera 412 that includes a low density pixel array 416, a third mini-camera 420 that includes a peripheral vision array 424, and a fourth mini-camera 428 that includes a central vision array 432. Further, each of the mini-cameras 404, 412, 420, and 428 includes associated support circuitry 436. Opaque barriers 438 are disposed adjacent the pixel arrays 408, 416, 424, and 432 to prevent crosstalk between the mini-cameras 404, 412, 420, and 428. The mini-cameras 404, 412, 420, and 428 may cooperate to perform certain tasks and may perform other tasks individually. Specifically, the pixel arrays 408, 416, 424, and 432 in the mini-cameras 404, 412, 420, and 428 may be configured for the specific tasks, as described further below with reference to FIG. 5, which illustrates an exemplary implementation of the sensor 400.

FIG. 5 is a perspective view of a digital camera 500 that includes the sensor 400 in accordance with an exemplary embodiment of the present invention. In the illustrated embodiment, the mini-cameras 404 and 412 on the sensor 400 may cooperate to save battery life in the digital camera 500. For example, the mini-cameras 404 and 412 may cooperate to save energy used by a preview screen 504 of the camera 500, as illustrated in FIG. 5. The preview screen 504 may facilitate observation of a target scene before capturing an image of the scene. While the camera 500 may be capable of capturing images with a very high resolution using the high density pixel array 408, the preview screen 504 may only produce a relatively low resolution image to facilitate picture taking. For example, a user may place the camera 500 in “view finder” mode and use the preview screen 504 to align and/or focus the camera. This limited functionality for the preview screen 504 allows for a low resolution output, which is cost efficient. However, the user may want high resolution pictures to allow for quality enlargements of the resulting photographs and so forth. Accordingly, the high density pixel array 408 may include several mega pixels, while the preview screen 504 may only utilize a few hundred thousand pixels or less.

As indicated above, the preview screen 504 shown in FIG. 5 has lower resolution capabilities compared to the high density pixel array 408 shown in FIG. 4. Accordingly, if the high density pixel array 408 is utilized to produce the image for the preview screen 504, the resolution produced by the high density pixel array 408 should be reduced for display on the preview screen 504. This can create inefficiencies in processing by requiring conversion from high resolution to low resolution. Further, running a high resolution array, such as the high density pixel array 408, requires more power than a lower resolution array. Accordingly, embodiments of the present invention may use the low density array 416 to produce an image on the preview screen 504 for picture alignment and focusing. When the picture is ready to be taken (e.g., an activation button 404 is depressed), the sensor 400 may switch over to the high density array 408 to actually take the picture. This may simplify operation and reduce the consumption of power by the camera 500. Using the low density array 416 may facilitate low power, fast image acquisition for view finder mode and any video applications of the sensor.

It should be noted that the above-referenced power saving function is merely exemplary and many additional functions may also be achieved utilizing combinations of the high density pixel array 408 and the low density pixel array 416. For example, the low density array 416 may be utilized along with a processor to monitor certain conditions (e.g., a blinking light or other optical signal or indicator in the image scene) before activating the high density array 408. In another example, because bigger pixels capture more light, the low density array 416 may be utilized for providing color images while the high density array 408 with no color filters is used to provide monochrome images for high resolution luminescence information about the image. This may be desirable for an application wherein more spatial resolution is desired than color resolution.

In one embodiment, the sensor 400 may utilize the third mini-camera 420 to mimic human peripheral vision. The peripheral vision array 424, which is a component of the mini-camera 420, includes a low density pixel area 440 and a high density pixel area 444. The low density pixel area 440 includes pixels that are larger than those in the high density pixel area 444. Indeed, in the exemplary embodiment, the pixels in the low density pixel area 440 are approximately twice the size of the pixels in the high density pixel area 444. The high density pixel area 444 is in a central portion of the array 424 and the low density pixel area 440 is around the perimeter of the array 424. Accordingly, images produced using the array 424 may imitate human vision, which focuses on a central item and has less resolution around the perimeter. Also, because the larger pixels in the low density area 440 are more sensitive to light, they may be utilized to detect motion and activate the high density pixel area 440 or a separate array (e.g., high density array 408) to provide a clearer image of an item passing into view. The low density area 440 may include a color filter that is configured to facilitate motion detection (e.g., monochrome). Further, the low density area 440 may include infrared detectors to facilitate detection of movement in the dark. It should also be noted that similar functionality may be achieved using separate arrays. For example, the low density array 416 may be utilized to detect motion and the high density central vision array 432 may be utilized to provide a high resolution view of a central area. The low density area 440 may use no color filter to further enhance its sensitivity to motion detection or it could be equipped with a special uniform color filter to facilitate efficient and rapid detection of movements of elements with a particular color. More than one such array could be used to discern motion of scene elements with specific pre-defined colors. This could be particularly useful in automotive or machine vision applications.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An image sensor, comprising:
a substrate;
a plurality of pixel cell arrays disposed on the substrate;
a first array of the plurality of pixel cell arrays including pixels of a first size;
a second array of the plurality of pixel cell arrays including pixels of a second size, the second size differing from the first size; and
a plurality of photographic lenses, each of the plurality of photographic lenses arranged to focus light onto one array of the plurality of pixel cell arrays.

2. The image sensor of claim 1, wherein the pixels of the first size are larger than the pixels of the second size.

3. The image sensor of claim 2, comprising a monochrome filter, wherein the pixels of the first size are configured to receive light through the monochrome filter.

4. The image sensor of claim 2, comprising a multi-colored filter, wherein the pixels of the second size are configured to receive light through the multi-colored filter.

5. The image sensor of claim 1, comprising:
a first photographic lens of the plurality of photographic lenses with a focus distance that differs from one or both of the photographic lenses that focus light on the first and second arrays; and
a third array of the plurality of pixel cell arrays, wherein the third array of the plurality of pixel cell arrays is configured to receive light through the first photographic lens.

6. The image sensor of claim 1, wherein the pixels of the first size are configured to perform a first aspect of imaging and the pixels of the second size are configured to perform a second aspect of imaging.

7. The image sensor of claim 1, comprising a block of support circuitry disposed between the first array and the second array to reduce crosstalk between the first array and the second array.

8. A digital camera comprising:
a substrate;
a first mini-camera coupled to the substrate, the first mini-camera comprising:
a first pixel array comprising a first plurality of pixels;
a first photographic lens configured to direct light to the first pixel array; and
a first filter configured to filter the light before it reaches the first pixel array; and
a second mini-camera coupled to the substrate, the second mini-camera comprising:
a second pixel array comprising a second plurality of pixels, wherein the second plurality of pixels includes pixels with different characteristics than those of the first plurality of pixels; and
a second photographic lens configured to direct light to the second pixel array.

9. The digital camera of claim 8, wherein the second mini-camera comprises a second filter configured to filter the light before it reaches the second pixel array.

10. The digital camera of claim 9, wherein the first filter comprises a first color filter and the second filter comprises a second color filter with a different color than the first color filter.

11. The digital camera of claim 8, wherein the second pixel array is disposed around the first pixel array and the second plurality of pixels are larger than the first plurality of pixels to mimic peripheral vision.

12. The digital camera of claim 8, wherein the second pixel array comprises a first group of pixels arranged at a center portion of the second pixel array and a second group of pixels arranged about a perimeter of the second pixel array.

13. The digital camera of claim 12, wherein each pixel in the first group of pixels is a first size and each pixel in the second group is a second size different than the first size.

14. The digital camera of claim 12, wherein a characteristic of at least one feature of pixels of the first group of pixels is different from a corresponding characteristic of a feature of pixels of the second group of pixels.

15. The digital camera of claim 8, comprising a preview screen.

16. The digital camera of claim 15, wherein the first pixel array has a lower pixel density than the second pixel array and the first pixel array is configured to facilitate image projection on the preview screen.

17. The digital camera of claim 16, wherein the first mini-camera is configured to activate the second pixel array to capture a digital photograph.

18. The image sensor of claim 8, comprising a block of support circuitry disposed between the first pixel array and the second pixel array, wherein the block support circuitry is opaque and arranged to reduce crosstalk between the first pixel array and the second pixel array.

19. An image sensor, comprising:
a substrate;
a plurality of pixel cell arrays disposed on the substrate;
a first array of the plurality of pixel cell arrays including pixels of a first size;
a second array of the plurality of pixel cell arrays including pixels of a second size, the second size differing from the first size;
a plurality of photographic lenses, each of the plurality of photographic lenses arranged to focus light onto one of the plurality of pixel cell arrays; and
a block of support circuitry disposed between the first array and the second array, wherein the block support circuitry is opaque and arranged to reduce crosstalk between the first array and the pixel array.

20. An image sensor, comprising:
a substrate;
a plurality of pixel cell arrays disposed on the substrate;
a first array of the plurality of pixel cell arrays including pixels of a first size;
a second array of the plurality of pixel cell arrays including pixels of a second size, the second size differing from the first size; and
a plurality of photographic lenses, each of the plurality of photographic lenses arranged to focus light onto one of the plurality of pixel cell arrays, wherein a first lens of the plurality of photographic lenses is configured to focus at a first distance and a second lens of the plurality of photographic lenses is configured to focus at a second distance that is different from the first distance.

21. The image sensor of claim 20, comprising a colored filter, wherein the first lens is configured to receive light through the colored filter.

22. The image sensor of claim 20, comprising different color filters correspondingly arranged adjacent the plurality of pixel cell arrays.

23. The image sensor of claim 20, comprising a Bayer pattern filter, wherein the first lens or the first array is configured to receive light through the Bayer pattern filter.

24. The image sensor of claim 20, comprising a third lens configured to focus at a third distance that is different from both the first and second distances.
